(19) United States
(12) Patent Application Publication
(10) Pub. No.: US 2002/0023153 A1
(43) Pub. Date: Feb. 21, 2002

(54) System and method for monitoring time-based cost of using information

(76) Inventor: Byung Joon Park, Ulsan (KR)

Correspondence Address: Aaron R. Wininger, Esq., Squire, Sanders & Dempsey LLP, 600 Hansen Way, Palo Alto, CA, 94304, US

(21) Appl. No.: 09/918,685

(22) Filed: Jul. 27, 2001

Related U.S. Application Data
(60) Provisional application No. 60/305,332, filed on Jul. 13, 2001.

(30) Foreign Application Priority Data
Aug. 10, 2000 (KR) 2000-0046278

(51) Int. Cl. G06F 15/16

(52) U.S. Cl. 709/224; 709/248

(57) ABSTRACT

A system for monitoring time-based cost of using information comprises a client engine and timer. The engine initiates and stops a timer that measures elapsed time between receiving information and receiving a signal to terminate displaying the signal. The engine also sends information associated with a tag embedded in the received information, a termination signal, and measured time to a server for recording in a database for later billing.

### PRIORITY REFERENCE TO PRIOR APPLICATION

This application claims benefit of Korean patent application serial number 2000-0046278, entitled “A Method to Monitor the Use of Information with Fee on the Internet,” filed on Aug. 10, 2000, by inventor Byung Joon Park. Further, this application claims benefit of and incorporates by reference U.S. patent application serial No. 60/______, entitled “DMWV Systems and Methods,” filed on Jul. 13, 2001, by inventor Byung Joon Park.

### TECHNICAL FIELD

This invention relates generally to monitoring the use of information, and more particularly, but not exclusively, provides a system and method for monitoring time-based cost of using information.

### BACKGROUND

Conventionally, client computers can download information from servers over a network. In some cases, downloading information is free, while in other cases, downloading information requires payment of a fee, which may either be a flat fee, a fee corresponding to the amount of information, a time-based fee, or other type of fee. In the case of time-based fees, the server that serves the information must monitor how long the client is using downloaded information. In cases where multiple clients are downloading information from a single server, much processor time of the single server will be spent with monitoring time for multiple downloads, thereby possibly limiting the server's ability to effectively serve other client requests as well as accurately monitoring time for downloaded information.

Accordingly, a new and improved system and method may be needed for monitoring the time-based cost of information use.

### SUMMARY

The present invention provides a system for monitoring the time-based cost of using information. The system comprises a client-based engine that receives information from a server over a network. The information may include a tag that has an information identifier corresponding to the received information. Upon receipt of the information, the client-based engine begins a timer that counts until receipt, from a user, of a termination signal. The client-based engine then sends a termination signal, the information identifier, and amount of time measured by the timer to the server. A server-based engine can then record the information identifier and amount of time in a database to later enable billing for use of the information.

The present invention further provides a method for monitoring the time-based cost of downloaded information, comprising: downloading information including a tag, the tag including an information identifier; starting a timer; displaying the information; receiving a termination signal from a user; stopping the timer; and sending a termination signal, the information identifier, and accrued time to a server for storing in a database.

Accordingly, the system and method may advantageously monitor time-based cost of using information without overwhelming a server with multiple timing requirements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network topography in accordance with an embodiment of the invention;

FIG. 2 is a block diagram illustrating a client computer of FIG. 1.;

FIG. 3 illustrates a block diagram of a memory device of FIG. 2 according to an embodiment of the invention;

FIG. 4 is a block diagram illustrating a server of FIG. 1 according to an embodiment of an invention;

FIG. 5 is a block diagram illustrating a memory device of FIG. 4 according to an embodiment of the invention;

FIG. 6 is a flowchart illustrating a method of monitoring the time-based cost of using information downloaded from a server;

FIG. 7 is a flowchart illustrating an alternative method of monitoring the time-based cost of using information downloaded from a server; and

FIG. 8 is a flowchart illustrating a method to store time-based cost of information in a database.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

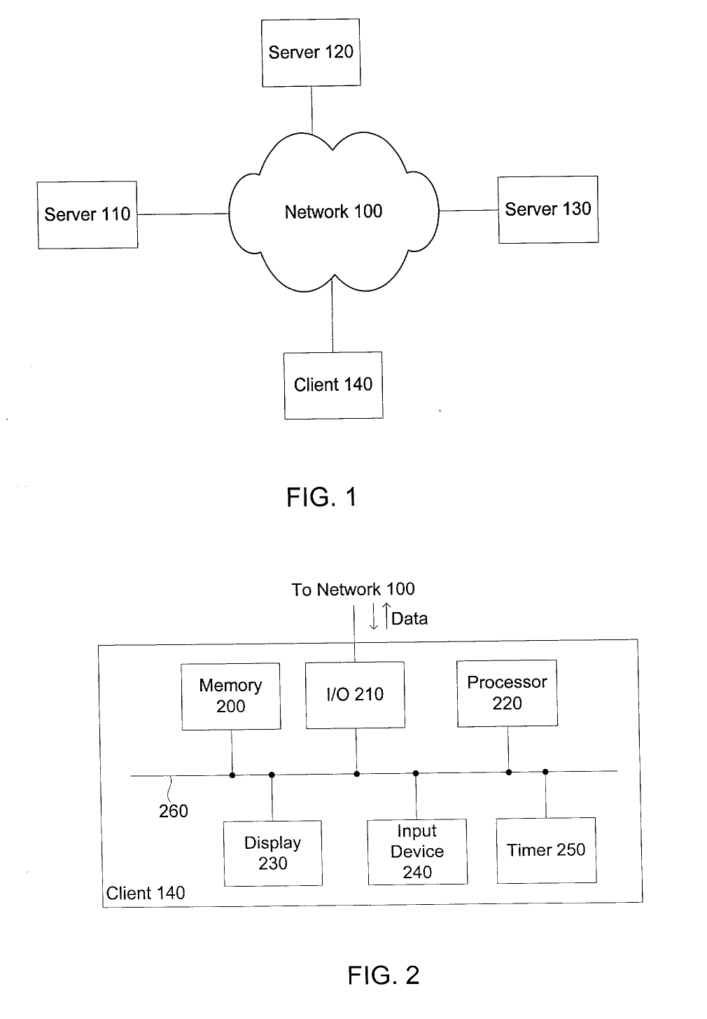

FIG. 1 is a block diagram illustrating a network topography according to an embodiment of the invention. The topography includes servers 110, 120 and 130, and client 140 communicatively coupled to a network 100, such as the Internet. Servers 110, 120 and 130 may include web servers hosting websites. Client 140 may include a personal digital assistant (“PDA”), wireless phone, computer, or any other device capable to communicate with a network. Further, although only three servers and one client are shown coupled to the network, in an embodiment of the invention, any number of clients and servers may be coupled to the network 100.

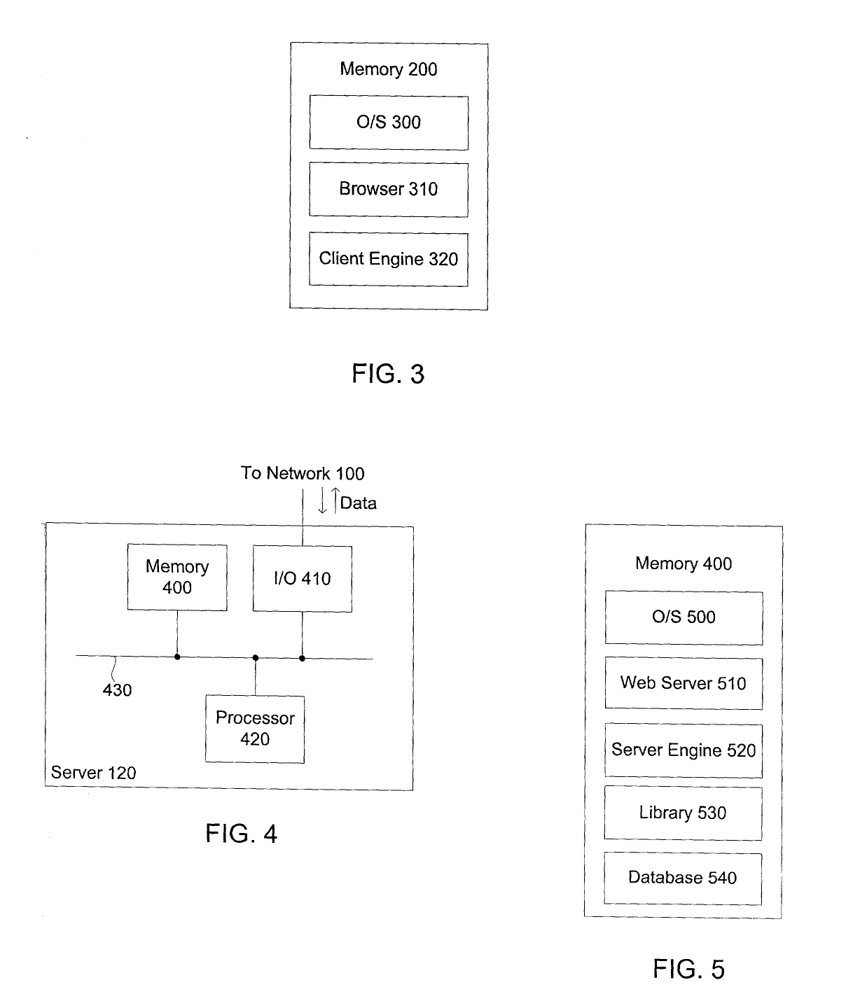

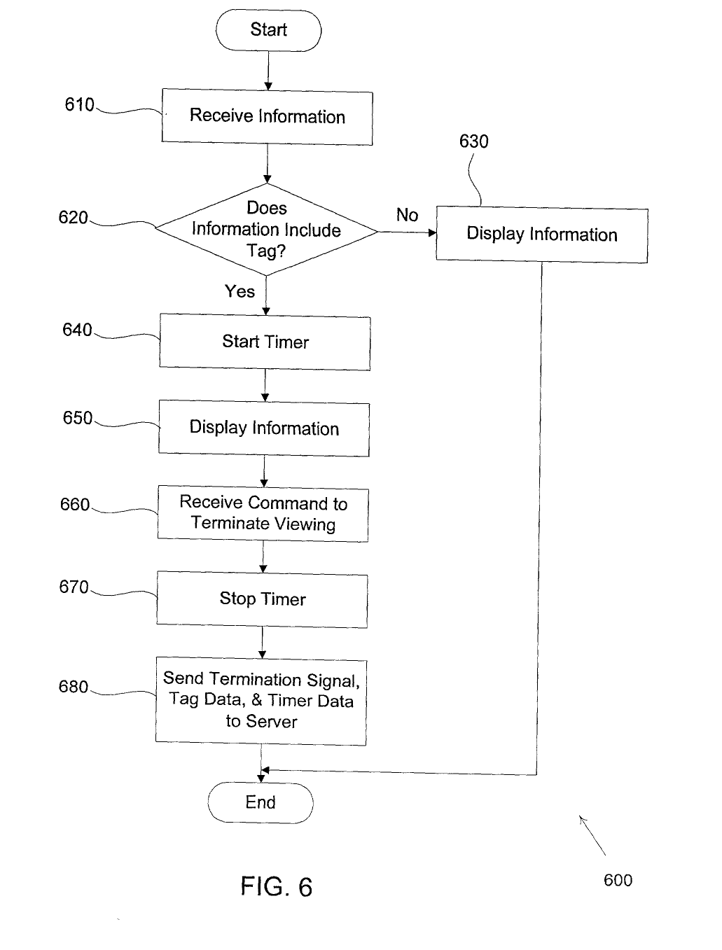

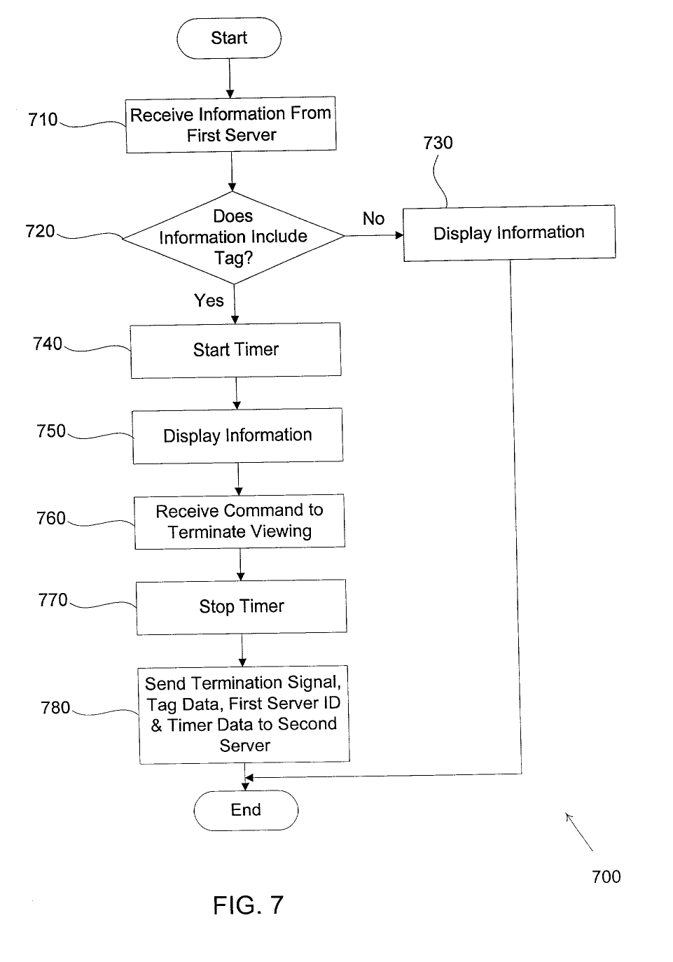

FIG. 2 is a block diagram illustrating a client 140 in accordance with an embodiment of the invention. The client 140 includes a memory device 200, input/output (I/O) interface 210, processor 220, display 230 input device 240, and timer 250, all communicatively coupled together via system bus 260. In an embodiment of the invention, memory 200 may include RAM, ROM, FLASH memory, a hard drive, disk drive, or any other type of memory device or combination of memory devices. The contents of memory 200 will be discussed in further detail in conjunction with FIG. 3. I/O interface 210 communicatively couples client 140 to network 100. Processor 220 may include an Intel Pentium® processor or other processor and processes programs stored in memory 200. Display 230 may include a monitor or other device for displaying data. Input device 240 may include a mouse, trackball, keyboard or other input device or combination thereof. Timer 250 measures time upon receiving an instruction from an engine 320 (FIG. 3), as will be discussed in further detail below in conjunction with FIG. 6 and FIG. 7.

FIG. 3 illustrates a block diagram of a memory device 200 according to an embodiment of the invention. Memory 200 includes an operating system (O/S) 300, such as Windows NT®; a web browser 310, such as Internet Explorer; and a client engine 320. In one embodiment of the invention, client engine 320, in conjunction with browser 310, retrieves information from a server 110, 120 or 130 and then sends a termination signal, information identifier, and time data to the server 110, 120 or 130, as will be discussed in further detail in conjunction with FIG. 6 and FIG. 7. The server 110, 120 or 130 can then record the data from the client 140 into a database so as to later bill a user of client 140 for the information use.

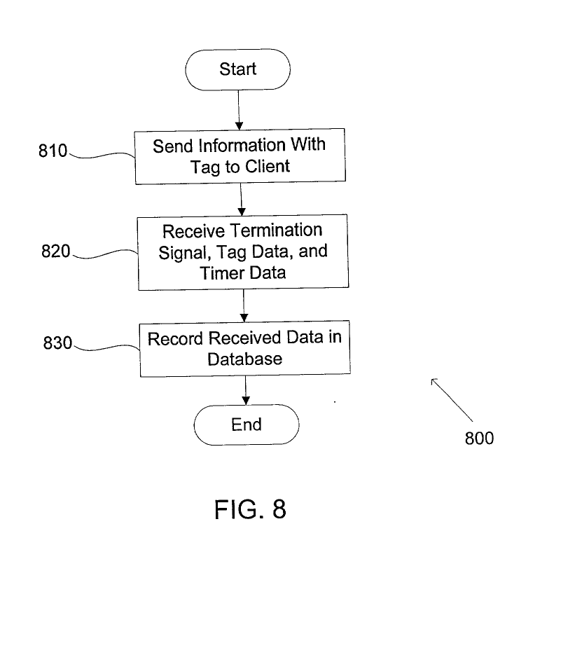

In another embodiment, memory 200 may also include an aggregation engine (not shown), as disclosed in U.S. patent application No.______/______, filed______, and entitled “System and Method for Aggregating Website Contents” by inventor Byung Joon Park, which is hereby incorporated by reference. The aggregation engine (also referred to as a DMWV Object Converter Engine in the above-mentioned patent application) enables a user to aggregate subsets of content from multiple websites and view the content simultaneously on a single display. For example, a user may aggregate, into one web page, a search engine box from Yahoo!, local weather from the weather channel, and a shopping search engine box from Amazon. Therefore, the embodiment having the aggregation engine and the client engine 320 enables a client computer to download user-selected subsets of content from a plurality of websites and time the usage of the content subsets. Further, client engine 320 can then communicate the subsets used to a server for billing purposes, as will be described in further detail below in conjunction with FIG. 6, FIG. 7, and FIG. 8.

FIG. 4 is a block diagram illustrating a server 120 according to an embodiment of an invention. Note that, in an embodiment of the invention, server 110 and server 130 may be substantially similar to server 120. Server 120 may include a memory device 400, I/O 410, and processor 420, all communicatively coupled together via system bus 430. In an embodiment of the invention, server 120 may also include an input device (not shown) and/or a display (not shown). Memory device 400 stores software to provide information to clients and stores billing data associated with the clients. Contents of memory 400 will be discussed in further detail in conjunction with FIG. 5. I/O 410 communicatively couples server 120 to network 100 so that server 120 may communicate with clients, such as client 140. Processor 420 may be an Intel Pentium® processor or other processor and executes software stored in memory 400.

FIG. 5 illustrates a block diagram of a memory device 400 according to an embodiment of the invention. Memory 400 includes O/S 500, web server 510, server engine 520, library 530, and database 540. O/S 500 may include Windows NT®, Linux, or any other operating system. Web server 510 serves information via web pages from library 530. Server engine 520, in an embodiment of the invention, may embed tags having information identifiers in web pages in library 530. Alternatively, web pages in library 530 may have tags pre-embedded. In addition, server engine 520 may receive termination signals and other data from clients and update database 540 accordingly, as will be discussed further in conjunction with FIGS. 6, 7, and 8. Database 540 stores billing information for clients that request data from servers.

FIG. 6 is a flowchart illustrating a method 600 of monitoring the time-based cost of using information downloaded from a server, such as server 120. In an embodiment of the invention, client engine 320 may execute method 600. After a client, such as client 140, requests information from a server, such as server 120, via techniques well known to those of ordinary skill in art, a client receives (610) information. Next, it is determined (620) if the information includes a tag, which may include an information identifier, data identifying the requesting client and/or other data. If the information does not include a tag, then the information is displayed (630) and the method ends.

If the information does contain a tag, then a timer, such as timer 250, is started (640). The information is then displayed (650) until a command to terminate viewing the information is received (660) from, for example, a user. After receiving the command to terminate viewing, the timer is stopped (670). A termination signal, tag data, and timer data is then sent (680) to the server, which can then update a database to reflect the information usage, as will be discussed in further detail in conjunction with FIG. 8. The method 600 then ends. Accordingly, the method 600 enables a client, in place of a server, to track time for time-based fees for using information thereby reducing the burden on a server to keep track of time.

In another embodiment of the invention, method 600 may also incorporate aggregation technology, as disclosed in the above-mentioned U.S. Patent Application entitled “System and Method for Aggregating Website Contents.” Accordingly, user-specified subsets of content from multiple web pages may be displayed at user-specified coordinates on a single display device, such as display 230. Therefore, multiple instances of method 600 may run simultaneously. Further, in an embodiment of the invention using the aggregation technology, additional data may be sent (680) to the server including data identifying subsets of information that were viewed, thereby possibly enabling billing at a reduced rate since only subsets of information were used.

FIG. 7 is a flowchart illustrating an alternative method 700 of monitoring the time-based cost of using information downloaded from a server, such as server 120. In an embodiment of the invention, client engine 320 may execute method 700. After a client, such as client 140, requests information from a first server, such as server 120, via techniques well known to those of ordinary skill in art, a client receives (710) information. Next, it is determined (720) if the information includes a tag, which may include an information identifier, data identifying the requesting client, and/or other data. If the information does not include a tag, then the information is displayed (730) and the method ends.

If the information does contain a tag, then a timer, such as timer 250, is started (740). The information is then displayed (750) until a command to terminate viewing the information is received (760) from, for example, a user. After receiving the command to terminate viewing, the timer is stopped (770). A termination signal, tag data, a first server identifier, and timer data is then sent (780) to a second server, such as server 110, which can then update a database to reflect the information usage, as will be discussed in further detail in conjunction with FIG. 8. The method 700 then ends. Accordingly, the method 700 enables a client to track time for cost-based use information and report the accrued time to a second server, thereby further reducing the burden on a first server to keep track of time and update a database accordingly.

In another embodiment of the invention, method 700 may also incorporate aggregation technology, as disclosed in the above-mentioned U.S. Patent Application entitled “System and Method for Aggregating Website Contents.” Accordingly, user-specified subsets of content from multiple web pages may be displayed at once at user-specified coordinates on a single display device, such as display 230. Therefore, multiple instances of method 700 may run simultaneously. Further, in an embodiment of the invention using the aggregation technology, additional data may be sent (780) to the second server including information identifying subsets of information that were viewed, thereby possibly enabling billing at a reduced rate since only subsets of information were used.

FIG. 8 is a flowchart illustrating a method 800 to store time-based cost of information in a database, such as database 540. In one embodiment of the invention, server engine 520 may execute method 800. Further, in another embodiment of the invention, multiple instances of method 800 may run concurrently. After receiving a request from a client for information, information with an embedded tag is sent (810) to the client. In an embodiment of the invention, the tag may be previously embedded in the information and include an information identifier. In another embodiment of the invention, server engine 520 may embed a tag into the information, the tag including an information identifier, an ID corresponding to the requesting client, and/or an ID corresponding to the server serving the information.

After a client receives the information and a user views it, a termination signal is received (820) from the client. In addition, tag data and timer data may also be received (820). The tag data includes an information identifier and possibly a client identifier and/or server identifier. In an alternative embodiment of the invention using aggregation technology, as described in the above-mentioned U.S. Patent Application entitled “System and Method for Aggregating Website Contents,” additional data indicating which subset of data was viewed may also be received. The tag data, timer data and any other data necessary to enable billing for use of the information (e.g., date and/or time of transaction, etc.) is then recorded (830) in a database, such as database 540. In addition, if using the aggregation technology mentioned above, information identifying the subset of data viewed may also be recorded (830) into a database.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, lo using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving, from at least one server, content information having an embedded tag;
displaying the content information;
receiving a command to terminate displaying the content information;
calculating an amount of time from the displaying the content information until the receiving a command to terminate displaying the content information;
sending, to the at least one server, a termination signal, tag information associated with the tag, and the calculated amount of time.

2. The method of claim 1, wherein the tag information includes an information identifier.

3. The method of claim 1, wherein the tag includes a client identifier.

4. The method of claim 1, wherein the tag information includes a server identifier.

5. The method of claim 1, wherein the content information includes a web page.

6. The method of claim 1 further comprising displaying at lease one user-specified subset of the received content information as specified by an aggregation engine.

7. The method of claim 6, further comprising sending, to the server, data corresponding to the at least one subset.

8. The method of claim 6, wherein the at least one user-specified subset is displayed at user-specified coordinates.

9. A machine-readable medium having stored thereon instructions to:
receive, from at least one server, content information having an embedded tag;
display the content information;
receive a command to terminate displaying the content information;
calculate an amount of time from the displaying the content information until the receiving a command to terminate displaying the content information;
send, to the at least one server, a termination signal, tag information associated with the tag, and the calculated amount of time.

10. The machine-readable medium of claim 9, wherein the tag information includes an information identifier.

11. The machine-readable medium of claim 9, wherein the tag information includes a client identifier.

12. The machine-readable medium of claim 9, wherein the tag information includes a server identifier.

13. The machine-readable medium of claim 9, wherein the content information includes a web page.

14. The machine-readable medium of claim 9 further comprising an instruction to display at lease one user-specified subset of the received content information as specified by an aggregation engine.

15. The machine-readable medium of claim 14, further comprising an instruction to send, to the server, data corresponding to the at least one subset.

16. The machine-readable medium of claim 14, wherein the at least one user-specified subset is displayed at user-specified coordinates.

17. A system, comprising:
means for receiving, from at least one server, content information having an embedded tag;
means for displaying the content information;
means for receiving a command to terminate displaying the content information;
means for calculating an amount of time from the displaying the content information until the receiving a command to terminate displaying the content information;
means for sending, to the at least one server, a termination signal, tag information associated with the tag, and the calculated amount of time.

18. A method, comprising:
receiving, from at least one server, content information having an embedded tag;
displaying the content information;
receiving a command to terminate displaying content information;
calculating an amount of time from the displaying the content information until the receiving a command to terminate displaying the content information;
sending, to a second server, a termination signal, tag information associated with the tag, and the calculated amount of time.

19. The method of claim 18, wherein the tag information includes an information identifier.

20. The method of claim 18, wherein the tag information includes a client identifier.

21. The method of claim 18, wherein the tag information includes a server identifier.

22. The method of claim 18, wherein the content information includes a web page.

23. The method of claim 18 further comprising displaying at lease one user-specified subset of the received content information as specified by an aggregation engine.

24. The method of claim 23, further comprising sending, to the second server, data corresponding to the at least one subset.

25. The method of claim 23, wherein the at least one user-specified subset is displayed at user-specified coordinates.

26. A machine-readable medium having stored thereon instructions to:
receive, from at least one server, content information having an embedded tag;
display the content information;
receive a command to terminate displaying content information;
calculate an amount of time from the displaying the content information until the receiving a command to terminate displaying the content information;
send, to a second server, a termination signal, tag information associated with the tag, and the calculated amount of time.

27. The machine-readable medium of claim 26, wherein the tag information includes an information identifier.

28. The machine-readable medium of claim 26, wherein the tag information includes a client identifier.

29. The machine-readable medium of claim 26, wherein the tag information includes a server identifier.

30. The machine-readable medium of claim 26, wherein the content information includes a web page.

31. The machine-readable medium of claim 26 further comprising an instruction to display at lease one user-specified subset of the received content information as specified by an aggregation engine.

32. The machine-readable medium of claim 31, further comprising an instruction to send, to the second server, data corresponding to the at least one subset.

33. The machine-readable medium of claim 31, wherein the at least one user-specified subset is displayed at user-specified coordinates.

34. A system, comprising:
means for receiving, from at least one server, content information having an embedded tag;
means for displaying the content information;
means for receiving a command to terminate displaying content information;
means for calculating an amount of time from the displaying the content information until the receiving a command to terminate displaying the content information;
means for sending, to a second server, a termination signal, tag information associated with the tag, and the calculated amount of time.

35. An apparatus, comprising:
a timer capable to measure elapsed time between receiving content information and receiving a command to terminate viewing the content information;
a client engine, communicatively coupled to at least one server and to the timer, capable to receive, from the at least one server, the content information, the content information having an embedded tag; display the content information; receive a command to terminate displaying the content information; and sending, to the at least one server, a termination signal, tag information associated with the tag, and elapsed time, as measured by the timer, from receiving the content information to receiving the termination signal.

36. The machine-readable medium of claim 35, wherein the tag information includes an information identifier.

37. The apparatus of claim 35, wherein the tag information includes a client identifier.

38. The apparatus of claim 35, wherein the tag information includes a server identifier.

39. The apparatus of claim 35, wherein the content information includes a web page.

40. The apparatus of claim 35, further comprising an aggregation engine capable to aggregate subsets of content information from a plurality of websites.

41. The apparatus of claim 40, wherein the client engine is further capable to send, to the at least one server, information identifying subsets of content information viewed.

42. The apparatus of claim 35, wherein the client engine is further capable to send, to a second server, a termination signal, tag information associated with the tag, and elapsed time, as measured by the timer, from receiving the content information to receiving the termination signal.
